(19) United States
(12) Patent Application Publication
(10) Pub. No.: US 2026/0329559 A1
(43) Pub. Date: Oct. 22, 2026

(54) CODE CONVERSION AGENTIC ARCHITECTURE

(71) Applicant: T-Mobile USA, Inc., Bellevue, WA (US)

(72) Inventors: Arin Banerjee, Kent, WA (US); Prasad Vasantrao Changole, Issaquah, WA (US); Ankur Mattoo, Newcastle, WA (US); Ramesh Somayajula, Snohomish, WA (US); Chaitanya Talavata Laxminarayana, Austin, TX (US); Lakshmi Lalasa Yekkala, Redmond, WA (US)

(21) Appl. No.: 19/186,225

(22) Filed: Apr. 22, 2025

(51) Int. Cl. G06F 8/41; G06F 8/73; G06F 11/3604; G06F 11/3668

(52) U.S. Cl. CPC G06F 8/447; G06F 8/73; G06F 11/3604; G06F 11/3684

(57) ABSTRACT

Systems and methods for converting a source code file from a first programming language to a second programming language for execution within a target programming environment are disclosed herein. In some aspects, the system processes a source code file to determine one or more conversion issues that conflict or cause incompatibility with a target programming environment. The system processes, using an agentic architecture comprising a plurality of autonomous agents, based on the one or more conversion issues, the source code file to generate a translated source code file. The system processes the translated source code file to determine whether any conversion issues remain that conflict with the target programming environment. The system, based on determining no conversion issues remain, outputs the translated source code file.

### BACKGROUND

In the rapidly evolving landscape of software development, the need to convert code between different programming languages has become increasingly prevalent. This need arises from various factors, including the obsolescence of certain programming languages, the scarcity of developers proficient in those languages, and the need to provide compatibility with modern platforms. As technology advances, organizations often find themselves compelled to migrate their legacy systems to newer, more efficient programming environments to maintain competitiveness and operational efficiency.

Despite its importance, the process of code conversion is fraught with challenges. Manual code conversion is not only time-consuming but also prone to human error, which can significantly impact the quality and stability of the resulting code. The intricacies involved in translating the syntax and semantics of one programming language to another require a deep understanding of both the source and target languages. This complexity often leads to issues such as incomplete or incorrect translations, which can compromise the functionality and reliability of the software.

Moreover, the manual conversion process raises significant concerns regarding the security of the code. As developers translate code, there is a risk of introducing vulnerabilities that were not present in the original version. These security flaws can be exploited by malicious actors, leading to potential data breaches and other cyber threats. Ensuring that the converted code adheres to security best practices is a critical aspect of the conversion process, necessitating thorough reviews and testing.

Maintaining the converted code is another critical challenge. The maintainability of code can be essential for the long-term success of any software project. Poorly converted code can be difficult to understand and modify, leading to increased maintenance costs and longer development cycles. This is particularly problematic in large-scale projects where the codebase is extensive and complex. Ensuring that the converted code is clean, well-documented, and maintainable is crucial for the sustainability of the software.

Finally, extensive regression testing is required to validate the functionality of the converted code. Regression testing can help ensure that the new code performs as expected and that no new bugs have been introduced during the conversion process. This testing phase can be essential to guarantee that the software remains stable and reliable after the conversion. However, regression testing can be resource-intensive, requiring significant time and effort to execute comprehensively.

### BRIEF DESCRIPTION OF THE DRAWINGS

Detailed descriptions of implementations of the present invention will be described and explained through the use of the accompanying drawings.

FIG. 1 is a block diagram that illustrates a wireless communications system that can implement at least some aspects of the present technology.

FIG. 2 is a block diagram illustrating an example generative model that can be used to implement at least some aspects of the present technology.

FIG. 3 is a block diagram that illustrates components of a code conversion agentic architecture, according to at least some aspects of the present technology.

FIG. 4 is a flow diagram that illustrates an example process for executing a code conversion agentic architecture, according to at least some aspects of the present technology.

FIG. 5 is another flow diagram that illustrates an example process for executing a code conversion agentic architecture, according to at least some aspects of the present technology.

FIG. 6 is a block diagram that illustrates an example of a computer system in which at least some operations described herein can be implemented.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

The systems and methods described herein relate to converting a source code file from a first programming language to a second programming language, enabling execution within a target programming environment. Conventional systems for code conversion typically rely on manual processes or rudimentary automated tools that often fall short in addressing the complexities involved in translating code accurately and efficiently. These traditional methods are not only time-consuming but also prone to errors, leading to issues with code quality, stability, and security. The systems and methods described herein aim to overcome these limitations by introducing a sophisticated, automated approach to code conversion.

The technical problem addressed by the systems and methods described herein is the inherent difficulty in accurately converting code between programming languages while providing compatibility with the target programming environment. Conventional systems struggle with identifying and resolving conversion issues that arise due to differences in language syntax, semantics, and platform-specific requirements. These issues can lead to incomplete or incorrect translations, which compromise the functionality and reliability of the software. Additionally, manual conversion processes are resource-intensive and susceptible to human error, further exacerbating the problem.

To address these challenges, the systems and methods described herein employ an agentic architecture comprising a plurality of autonomous agents. These agents work collaboratively to process the source code file and identify any conversion issues that conflict or cause incompatibility with the target programming environment. By leveraging the capabilities of multiple autonomous agents, the system can efficiently analyze the source code and pinpoint specific areas that require attention. This distributed approach can help ensure a thorough examination of the code, significantly reducing the likelihood of overlooking critical conversion issues.

Once the conversion issues have been identified, the systems and methods described herein process the source code file based on these issues to generate a translated source code file. The autonomous agents work in parallel to apply the necessary transformations, such that the translated code adheres to the syntax and semantics of the target programming language. This collaborative processing not only enhances the accuracy of the conversion but also accelerates the overall process, making it more efficient than conventional methods. The system's ability to dynamically adapt to different conversion scenarios further enhances its robustness and reliability.

After generating the translated source code file, the systems and methods described herein perform a final validation to determine whether any conversion issues remain that conflict or cause incompatibility with the target programming environment. This can help ensure that the translated code is fully compatible and ready for execution. If no conversion issues are detected, the system outputs the translated source code file, which can then be deployed within the target environment. This comprehensive approach to code conversion, from initial analysis to final validation, can help ensure high-quality, stable, and secure code, addressing the shortcomings of conventional systems and providing a reliable solution for modern software development needs.

In some aspects, the systems and methods described herein provide for a system that processes a source code file to determine one or more conversion issues that conflict or cause incompatibility with a target programming environment. The system processes, using an agentic architecture comprising a plurality of autonomous agents, based on the one or more conversion issues, the source code file to generate a translated source code file. The system processes the translated source code file to determine whether any conversion issues remain that conflict or cause incompatibility with the target programming environment. The system, based on determining no conversion issues remain, outputs the translated source code file.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail, to avoid unnecessarily obscuring the descriptions of examples.

### Wireless Communications System

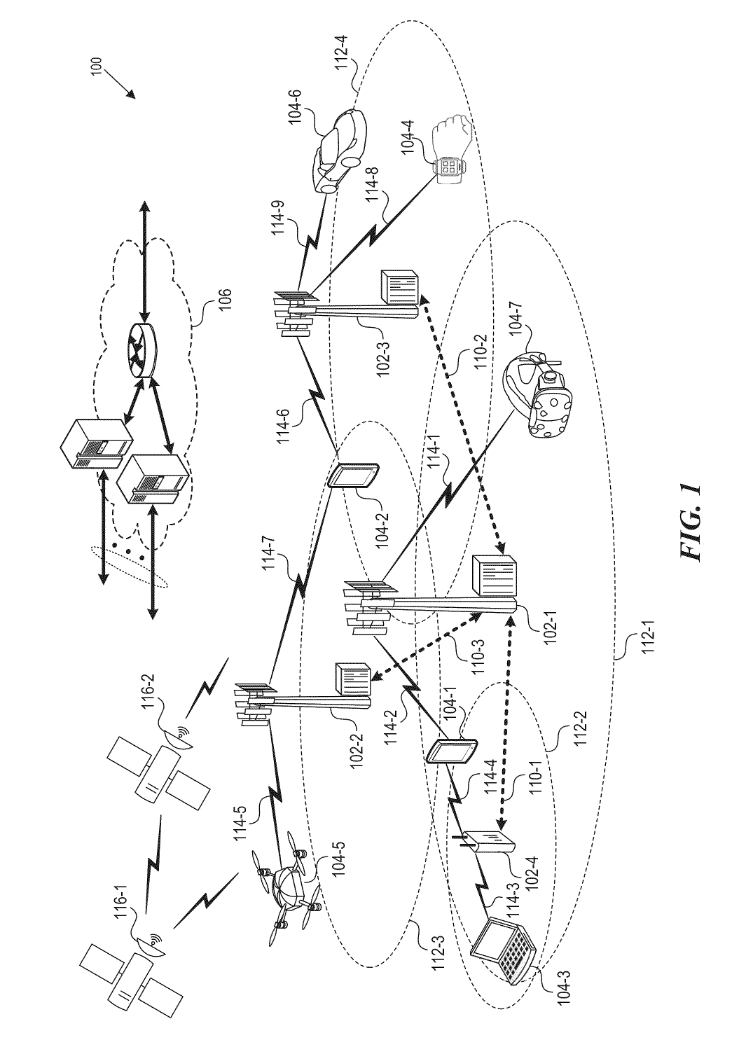

FIG. 1 is a block diagram that illustrates a wireless telecommunication network 100 (“network 100”) in which aspects of the disclosed technology are incorporated. The network 100 includes base stations 102-1 through 102-4 (also referred to individually as “base station 102” or collectively as “base stations 102”). A base station is a type of network access node (NAN) that can also be referred to as a cell site, a base transceiver station, or a radio base station. The network 100 can include any combination of NANs including an access point, radio transceiver, gNodeB (gNB), NodeB, eNodeB (eNB), Home NodeB or Home eNodeB, or the like. In addition to being a wireless wide area network (WWAN) base station, a NAN can be a wireless local area network (WLAN) access point, such as an Institute of Electrical and Electronics Engineers (IEEE) 802.11 access point.

The NANs of a network 100 formed by the network 100 also include wireless devices 104-1 through 104-7 (referred to individually as “wireless device 104” or collectively as “wireless devices 104”) and a core network 106. The wireless devices 104 can correspond to or include network 100 entities capable of communication using various connectivity standards. For example, a 5G communication channel can use millimeter wave (mmW) access frequencies of 28 GHz or more. In some implementations, the wireless device 104 can operatively couple to a base station 102 over a long-term evolution/long-term evolution-advanced (LTE/LTE-A) communication channel, which is referred to as a 4G communication channel.

The core network 106 provides, manages, and controls security services, user authentication, access authorization, tracking, internet protocol (IP) connectivity, and other access, routing, or mobility functions. The base stations 102 interface with the core network 106 through a first set of backhaul links (e.g., S1 interfaces) and can perform radio configuration and scheduling for communication with the wireless devices 104 or can operate under the control of a base station controller (not shown). In some examples, the base stations 102 can communicate with each other, either directly or indirectly (e.g., through the core network 106), over a second set of backhaul links 110-1 through 110-3 (e.g., X1 interfaces), which can be wired or wireless communication links.

The base stations 102 can wirelessly communicate with the wireless devices 104 via one or more base station antennas. The cell sites can provide communication coverage for geographic coverage areas 112-1 through 112-4 (also referred to individually as “coverage area 112” or collectively as “coverage areas 112”). The coverage area 112 for a base station 102 can be divided into sectors making up only a portion of the coverage area (not shown). The network 100 can include base stations of different types (e.g., macro and/or small cell base stations). In some implementations, there can be overlapping coverage areas 112 for different service environments (e.g., Internet of Things (IoT), mobile broadband (MBB), vehicle-to-everything (V2X), machine-to-machine (M2M), machine-to-everything (M2X), ultra-reliable low-latency communication (URLLC), machine-type communication (MTC), etc.).

The network 100 can include a 5G network 100 and/or an LTE/LTE-A or other network. In an LTE/LTE-A network, the term “eNBs” is used to describe the base stations 102, and in 5G new radio (NR) networks, the term “gNBs” is used to describe the base stations 102 that can include mmW communications. The network 100 can thus form a heterogeneous network 100 in which different types of base stations provide coverage for various geographic regions. For example, each base station 102 can provide communication coverage for a macro cell, a small cell, and/or other types of cells. As used herein, the term “cell” can relate to a base station, a carrier or component carrier associated with the base station, or a coverage area (e.g., sector) of a carrier or base station, depending on context.

A macro cell generally covers a relatively large geographic area (e.g., several kilometers in radius) and can allow access by wireless devices that have service subscriptions with a wireless network 100 service provider. As indicated earlier, a small cell is a lower-powered base station, as compared to a macro cell, and can operate in the same or different (e.g., licensed, unlicensed) frequency bands as macro cells. Examples of small cells include pico cells, femto cells, and micro cells. In general, a pico cell can cover a relatively smaller geographic area and can allow unrestricted access by wireless devices that have service subscriptions with the network 100 provider. A femto cell covers a relatively smaller geographic area (e.g., a home) and can provide restricted access by wireless devices having an association with the femto unit (e.g., wireless devices in a closed subscriber group (CSG), wireless devices for users in the home). A base station can support one or multiple (e.g., two, three, four, and the like) cells (e.g., component carriers). All fixed transceivers noted herein that can provide access to the network 100 are NANs, including small cells.

The communication networks that accommodate various disclosed examples can be packet-based networks that operate according to a layered protocol stack. In the user plane, communications at the bearer or Packet Data Convergence Protocol (PDCP) layer can be IP-based. A Radio Link Control (RLC) layer then performs packet segmentation and reassembly to communicate over logical channels. A Medium Access Control (MAC) layer can perform priority handling and multiplexing of logical channels into transport channels. The MAC layer can also use Hybrid ARQ (HARQ) to provide retransmission at the MAC layer, to improve link efficiency. In the control plane, the Radio Resource Control (RRC) protocol layer provides establishment, configuration, and maintenance of an RRC connection between a wireless device 104 and the base stations 102 or core network 106 supporting radio bearers for the user plane data. At the Physical (PHY) layer, the transport channels are mapped to physical channels.

Wireless devices can be integrated with or embedded in other devices. As illustrated, the wireless devices 104 are distributed throughout the network 100, where each wireless device 104 can be stationary or mobile. For example, wireless devices can include handheld mobile devices 104-1 and 104-2 (e.g., smartphones, portable hotspots, tablets, etc.); laptops 104-3; wearables 104-4; drones 104-5; vehicles with wireless connectivity 104-6; head-mounted displays with wireless augmented reality/virtual reality (AR/VR) connectivity 104-7; portable gaming consoles; wireless routers, gateways, modems, and other fixed-wireless access devices; wirelessly connected sensors that provide data to a remote server over a network; IoT devices such as wirelessly connected smart home appliances; etc.

A wireless device (e.g., wireless devices 104) can be referred to as a user equipment (UE), a customer premises equipment (CPE), a mobile station, a subscriber station, a mobile unit, a subscriber unit, a wireless unit, a remote unit, a handheld mobile device, a remote device, a mobile subscriber station, a terminal equipment, an access terminal, a mobile terminal, a wireless terminal, a remote terminal, a handset, a mobile client, a client, or the like.

A wireless device can communicate with various types of base stations and network 100 equipment at the edge of a network 100 including macro eNBs/gNBs, small cell eNBs/gNBs, relay base stations, and the like. A wireless device can also communicate with other wireless devices either within or outside the same coverage area of a base station via device-to-device (D2D) communications.

The communication links 114-1 through 114-9 (also referred to individually as “communication link 114” or collectively as “communication links 114”) shown in network 100 include uplink (UL) transmissions from a wireless device 104 to a base station 102 and/or downlink (DL) transmissions from a base station 102 to a wireless device 104. The downlink transmissions can also be called forward link transmissions while the uplink transmissions can also be called reverse link transmissions. Each communication link 114 includes one or more carriers, where each carrier can be a signal composed of multiple sub-carriers (e.g., waveform signals of different frequencies) modulated according to the various radio technologies. Each modulated signal can be sent on a different sub-carrier and carry control information (e.g., reference signals, control channels), overhead information, user data, etc. The communication links 114 can transmit bidirectional communications using frequency division duplex (FDD) (e.g., using paired spectrum resources) or time division duplex (TDD) operation (e.g., using unpaired spectrum resources). In some implementations, the communication links 114 include LTE and/or mmW communication links.

In some implementations of the network 100, the base stations 102 and/or the wireless devices 104 include multiple antennas for employing antenna diversity schemes to improve communication quality and reliability between base stations 102 and wireless devices 104. Additionally or alternatively, the base stations 102 and/or the wireless devices 104 can employ multiple-input, multiple-output (MIMO) techniques that can take advantage of multi-path environments to transmit multiple spatial layers carrying the same or different coded data.

In some examples, the network 100 implements 6G technologies including increased densification or diversification of network nodes. The network 100 can enable terrestrial and non-terrestrial transmissions. In this context, a Non-Terrestrial Network (NTN) is enabled by one or more satellites, such as satellites 116-1 and 116-2, to deliver services anywhere and anytime and provide coverage in areas that are unreachable by any conventional Terrestrial Network (TN). A 6G implementation of the network 100 can support terahertz (THz) communications. This can support wireless applications that demand ultrahigh quality of service (QoS) requirements and multi-terabits-per-second data transmission in the era of 6G and beyond, such as terabit-per-second backhaul systems, ultra-high-definition content streaming among mobile devices, AR/VR, and wireless high-bandwidth secure communications. In another example of 6G, the network 100 can implement a converged Radio Access Network (RAN) and Core architecture to achieve Control and User Plane Separation (CUPS) and achieve extremely low user plane latency. In yet another example of 6G, the network 100 can implement a converged Wi-Fi and Core architecture to increase and improve indoor coverage.

### Transformer for Neural Network

A "model," as used herein, can refer to a construct that is trained using training data to make predictions or provide probabilities for new data items, whether or not the new data items were included in the training data. For example, training data for supervised learning can include items with various parameters and an assigned classification. A new data item can have parameters that a model can use to assign a classification to the new data item. As another example, a model can be a probability distribution resulting from the analysis of training data, such as a likelihood of an n-gram occurring in a given language based on an analysis of a large corpus from that language. Examples of models include neural networks, support vector machines, decision trees, Parzen windows, Bayes, clustering, reinforcement learning, probability distributions, decision trees, decision tree forests, and others. Models can be configured for various situations, data types, sources, and output formats.

In some implementations, the model can be a neural network with multiple input nodes that receive input. The input nodes can correspond to functions that receive the input and produce results. These results can be provided to one or more levels of intermediate nodes that each produce further results based on a combination of lower-level node results. A weighting factor can be applied to the output of each node before the result is passed to the next layer node. At a final layer, ("the output layer") one or more nodes can produce a value classifying the input that, once the model is trained, can be used as the output. In some implementations, such neural networks, known as deep neural networks, can have multiple layers of intermediate nodes with different configurations, can be a combination of models that receive different parts of the input and/or input from other parts of the deep neural network, or are convolutions - partially using output from previous iterations of applying the model as further input to produce results for the current input.

A machine learning model can be trained with supervised learning, where the training data includes input and a desired output. A representation can be provided to the model. Output from the model can be compared to the desired output and, based on the comparison, the model can be modified, such as by changing weights between nodes of the neural network or parameters of the functions used at each node in the neural network (e.g., applying a loss function). After applying each of the input in the training data and modifying the model in this manner, the model can be trained to evaluate new input.

To assist in understanding the present disclosure, some concepts relevant to neural networks and machine learning (ML) are discussed herein. Generally, a neural network comprises a number of computation units (sometimes referred to as “neurons”). Each neuron receives an input value and applies a function to the input to generate an output value. The function typically includes a parameter (also referred to as a “weight”) whose value is learned through the process of training. A plurality of neurons may be organized into a neural network layer (or simply “layer”) and there may be multiple such layers in a neural network. The output of one layer may be provided as input to a subsequent layer. Thus, input to a neural network may be processed through a succession of layers until an output of the neural network is generated by a final layer. This is a simplistic discussion of neural networks and there may be more complex neural network designs that include feedback connections, skip connections, and/or other such possible connections between neurons and/or layers, which are not discussed in detail here.

A deep neural network (DNN) is a type of neural network having multiple layers and/or a large number of neurons. The term DNN may encompass any neural network having multiple layers, including convolutional neural networks (CNNs), recurrent neural networks (RNNs), multilayer perceptrons (MLPs), Generative Adversarial Networks (GANs), Variational Autoencoders (VAEs), and Auto-regressive Models, among others.

DNNs are often used as ML-based models for modeling complex behaviors (e.g., human language, image recognition, object classification) in order to improve the accuracy of outputs (e.g., more accurate predictions) such as, for example, as compared with models with fewer layers. In the present disclosure, the term “ML-based model” or more simply “ML model” may be understood to refer to a DNN. Training an ML model refers to a process of learning the values of the parameters (or weights) of the neurons in the layers such that the ML model is able to model the target behavior to a desired degree of accuracy. Training typically requires the use of a training dataset, which is a set of data that is relevant to the target behavior of the ML model.

As an example, to train an ML model that is intended to model human language (also referred to as a language model), the training dataset may be a collection of text documents, referred to as a text corpus (or simply referred to as a corpus). The corpus may represent a language domain (e.g., a single language), a subject domain (e.g., scientific papers), and/or may encompass another domain or domains, be they larger or smaller than a single language or subject domain. For example, a relatively large, multilingual and non-subject-specific corpus may be created by extracting text from online webpages and/or publicly available social media posts. Training data may be annotated with ground truth labels (e.g., each data entry in the training dataset may be paired with a label), or may be unlabeled.

Training an ML model generally involves inputting into an ML model (e.g., an untrained ML model) training data to be processed by the ML model, processing the training data using the ML model, collecting the output generated by the ML model (e.g., based on the inputted training data), and comparing the output to a desired set of target values. If the training data is labeled, the desired target values may be, e.g., the ground truth labels of the training data. If the training data is unlabeled, the desired target value may be a reconstructed (or otherwise processed) version of the corresponding ML model input (e.g., in the case of an autoencoder), or can be a measure of some target observable effect on the environment (e.g., in the case of a reinforcement learning agent). The parameters of the ML model are updated based on a difference between the generated output value and the desired target value. For example, if the value outputted by the ML model is excessively high, the parameters may be adjusted so as to lower the output value in future training iterations. An objective function is a way to quantitatively represent how close the output value is to the target value. An objective function represents a quantity (or one or more quantities) to be optimized (e.g., minimize a loss or maximize a reward) in order to bring the output value as close to the target value as possible. The goal of training the ML model typically is to minimize a loss function or maximize a reward function.

The training data may be a subset of a larger data set. For example, a data set may be split into three mutually exclusive subsets: a training set, a validation (or cross-validation) set, and a testing set. The three subsets of data may be used sequentially during ML model training. For example, the training set may be first used to train one or more ML models, each ML model, e.g., having a particular architecture, having a particular training procedure, being describable by a set of model hyperparameters, and/or otherwise being varied from the other of the one or more ML models. The validation (or cross-validation) set may then be used as input data into the trained ML models to, e.g., measure the performance of the trained ML models and/or compare performance between them. Where hyperparameters are used, a new set of hyperparameters may be determined based on the measured performance of one or more of the trained ML models, and the first step of training (i.e., with the training set) may begin again on a different ML model described by the new set of determined hyperparameters. In this way, these steps may be repeated to produce a more performant trained ML model. Once such a trained ML model is obtained (e.g., after the hyperparameters have been adjusted to achieve a desired level of performance), a third step of collecting the output generated by the trained ML model applied to the third subset (the testing set) may begin. The output generated from the testing set may be compared with the corresponding desired target values to give a final assessment of the trained ML model’s accuracy. Other segmentations of the larger data set and/or schemes for using the segments for training one or more ML models are possible.

Backpropagation is an algorithm for training an ML model. Backpropagation is used to adjust (also referred to as update) the value of the parameters in the ML model, with the goal of optimizing the objective function. For example, a defined loss function is calculated by forward propagation of an input to obtain an output of the ML model and a comparison of the output value with the target value. Backpropagation calculates a gradient of the loss function with respect to the parameters of the ML model, and a gradient algorithm (e.g., gradient descent) is used to update (i.e., “learn”) the parameters to reduce the loss function. Backpropagation is performed iteratively so that the loss function is converged or minimized. Other techniques for learning the parameters of the ML model may be used. The process of updating (or learning) the parameters over many iterations is referred to as training. Training may be carried out iteratively until a convergence condition is met (e.g., a predefined maximum number of iterations has been performed, or the value outputted by the ML model is sufficiently converged with the desired target value), after which the ML model is considered to be sufficiently trained. The values of the learned parameters may then be fixed and the ML model may be deployed to generate output in real-world applications (also referred to as “inference”).

In some examples, a trained ML model may be fine-tuned, meaning that the values of the learned parameters may be adjusted slightly in order for the ML model to better model a specific task. Fine-tuning of an ML model typically involves further training the ML model on a number of data samples (which may be smaller in number/cardinality than those used to train the model initially) that closely target the specific task. For example, an ML model for generating natural language that has been trained generically on publicly-available text corpora may be, e.g., fine-tuned by further training using specific training samples. The specific training samples can be used to generate language in a certain style or in a certain format. For example, the ML model can be trained to generate a blog post having a particular style and structure with a given topic.

Some concepts in ML-based language models are now discussed. It may be noted that, while the term “language model” has been commonly used to refer to a ML-based language model, there could exist non-ML language models. In the present disclosure, the term “language model” may be used as shorthand for an ML-based language model (i.e., a language model that is implemented using a neural network or other ML architecture), unless stated otherwise. For example, unless stated otherwise, the “language model” encompasses LLMs.

A language model may use a neural network (typically a DNN) to perform natural language processing (NLP) tasks. A language model may be trained to model how words relate to each other in a textual sequence, based on probabilities. A language model may contain hundreds of thousands of learned parameters or in the case of a large language model (LLM) may contain millions or billions of learned parameters or more. As non-limiting examples, a language model can generate text, translate text, summarize text, answer questions, write code (e.g., PYTHON, JAVASCRIPT, or other programming languages), classify text (e.g., to identify spam emails), create content for various purposes (e.g., social media content, factual content, or marketing content), or create personalized content for a particular individual or group of individuals. Language models can also be used for chatbots (e.g., virtual assistance).

In recent years, there has been interest in a type of neural network architecture, referred to as a transformer, for use as language models. For example, the Bidirectional Encoder Representations from Transformers (BERT) model, the Transformer-XL model, and the Generative Pre-trained Transformer (GPT) models are types of transformers. A transformer is a type of neural network architecture that uses self-attention mechanisms in order to generate predicted output based on input data that has some sequential meaning (i.e., the order of the input data is meaningful, which is the case for most text input). Although transformer-based language models are described herein, it should be understood that the present disclosure may be applicable to any ML-based language model, including language models based on other neural network architectures such as recurrent neural network (RNN)-based language models.

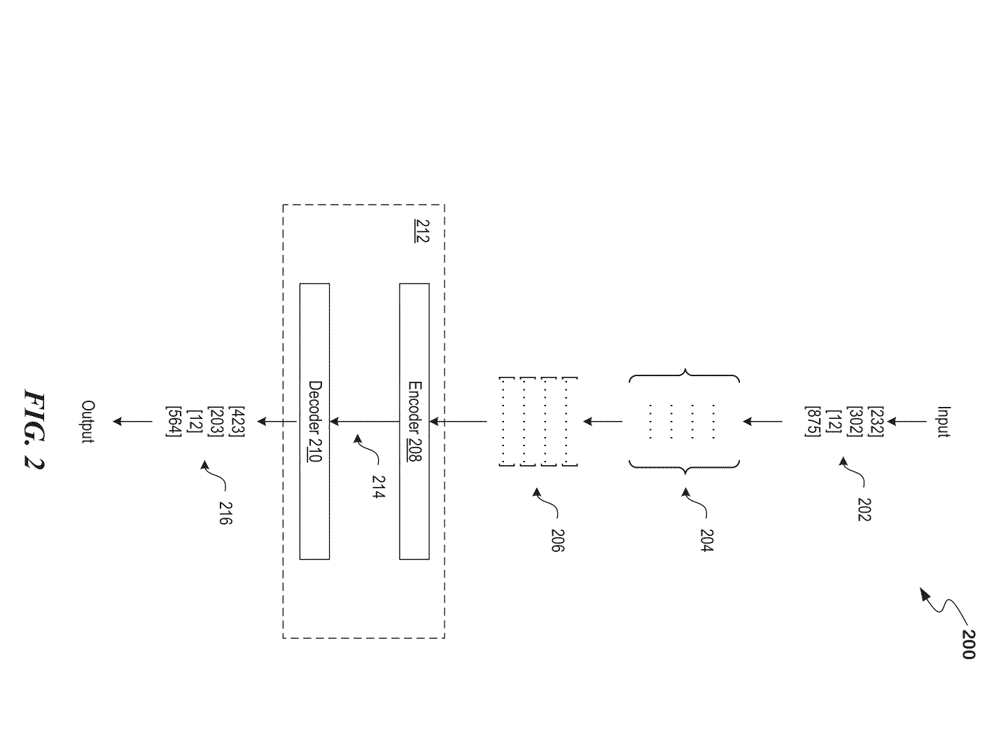

FIG. 2 is a block diagram of an example transformer 212. A transformer is a type of neural network architecture that uses self-attention mechanisms to generate predicted output based on input data that has some sequential meaning (i.e., the order of the input data is meaningful, which is the case for most text input). Self-attention is a mechanism that relates different positions of a single sequence to compute a representation of the same sequence. Although transformer-based language models are described herein, it should be understood that the present disclosure may be applicable to any machine learning (ML)-based language model, including language models based on other neural network architectures such as recurrent neural network (RNN)-based language models.

The transformer 212 includes an encoder 208 (which can comprise one or more encoder layers/blocks connected in series) and a decoder 210 (which can comprise one or more decoder layers/blocks connected in series). Generally, the encoder 208 and the decoder 210 each include a plurality of neural network layers, at least one of which can be a self-attention layer. The parameters of the neural network layers can be referred to as the parameters of the language model.

The transformer 212 can be trained to perform certain functions on a natural language input. For example, the functions include summarizing existing content, brainstorming ideas, writing a rough draft, fixing spelling and grammar, and translating content. Summarizing can include extracting key points from an existing content in a high-level summary. Brainstorming ideas can include generating a list of ideas based on provided input. For example, the ML model can generate a list of names for a startup or costumes for an upcoming party. Writing a rough draft can include generating writing in a particular style that could be useful as a starting point for the user’s writing. The style can be identified as, e.g., an email, a blog post, a social media post, or a poem. Fixing spelling and grammar can include correcting errors in an existing input text. Translating can include converting an existing input text into a variety of different languages. In some embodiments, the transformer 212 is trained to perform certain functions on other input formats than natural language input. For example, the input can include objects, images, audio content, or video content, or a combination thereof.

The transformer 212 can be trained on a text corpus that is labeled (e.g., annotated to indicate verbs, nouns) or unlabeled. Large language models (LLMs) can be trained on a large unlabeled corpus. The term “language model,” as used herein, can include an ML-based language model (e.g., a language model that is implemented using a neural network or other ML architecture), unless stated otherwise. Some LLMs can be trained on a large multi-language, multi-domain corpus to enable the model to be versatile at a variety of language-based tasks such as generative tasks (e.g., generating human-like natural language responses to natural language input). FIG. 2 illustrates an example of how the transformer 212 can process textual input data. Input to a language model (whether transformer-based or otherwise) typically is in the form of natural language that can be parsed into tokens. It should be appreciated that the term “token” in the context of language models and Natural Language Processing (NLP) has a different meaning from the use of the same term in other contexts such as data security. Tokenization, in the context of language models and NLP, refers to the process of parsing textual input (e.g., a character, a word, a phrase, a sentence, a paragraph) into a sequence of shorter segments that are converted to numerical representations referred to as tokens (or “compute tokens”). Typically, a token can be an integer that corresponds to the index of a text segment (e.g., a word) in a vocabulary dataset. Often, the vocabulary dataset is arranged by frequency of use. Commonly occurring text, such as punctuation, can have a lower vocabulary index in the dataset and thus be represented by a token having a smaller integer value than less commonly occurring text. Tokens frequently correspond to words, with or without white space appended. In some examples, a token can correspond to a portion of a word.

For example, the word “greater” can be represented by a token for [great] and a second token for [er]. In another example, the text sequence “write a summary” can be parsed into the segments [write], [a], and [summary], each of which can be represented by a respective numerical token. In addition to tokens that are parsed from the textual sequence (e.g., tokens that correspond to words and punctuation), there can also be special tokens to encode non-textual information. For example, a [CLASS] token can be a special token that corresponds to a classification of the textual sequence (e.g., can classify the textual sequence as a list, a paragraph), an [EOT] token can be another special token that indicates the end of the textual sequence, other tokens can provide formatting information, etc.

In FIG. 2, a short sequence of tokens 202 corresponding to the input text is illustrated as input to the transformer 212. Tokenization of the text sequence into the tokens 202 can be performed by some pre-processing tokenization module such as, for example, a byte-pair encoding tokenizer (the “pre” referring to the tokenization occurring prior to the processing of the tokenized input by the LLM), which is not shown in FIG. 2 for simplicity. In general, the token sequence that is inputted to the transformer 212 can be of any length up to a maximum length defined based on the dimensions of the transformer 212. Each token 202 in the token sequence is converted into an embedding vector 206 (also referred to simply as an embedding 206). An embedding 206 is a learned numerical representation (such as, for example, a vector) of a token that captures some semantic meaning of the text segment represented by the token 202. The embedding 206 represents the text segment corresponding to the token 202 in a way such that embeddings corresponding to semantically related text are closer to each other in a vector space than embeddings corresponding to semantically unrelated text. For example, assuming that the words “write,” “a,” and “summary” each correspond to, respectively, a “write” token, an “a” token, and a “summary” token when tokenized, the embedding 206 corresponding to the “write” token will be closer to another embedding corresponding to the “jot down” token in the vector space as compared to the distance between the embedding 206 corresponding to the “write” token and another embedding corresponding to the “summary” token.

The vector space can be defined by the dimensions and values of the embedding vectors. Various techniques can be used to convert a token 202 to an embedding 206. For example, another trained ML model can be used to convert the token 202 into an embedding 206. In particular, another trained ML model can be used to convert the token 202 into an embedding 206 in a way that encodes additional information into the embedding 206 (e.g., a trained ML model can encode positional information about the position of the token 202 in the text sequence into the embedding 206). In some examples, the numerical value of the token 202 can be used to look up the corresponding embedding in an embedding matrix 204 (which can be learned during training of the transformer 212).

The generated embeddings 206 are input into the encoder 208. The encoder 208 serves to encode the embeddings 206 into feature vectors 214 that represent the latent features of the embeddings 206. The encoder 208 can encode positional information (i.e., information about the sequence of the input) in the feature vectors 214. The feature vectors 214 can have very high dimensionality (e.g., on the order of thousands or tens of thousands), with each element in a feature vector 214 corresponding to a respective feature. The numerical weight of each element in a feature vector 214 represents the importance of the corresponding feature. The space of all possible feature vectors 214 that can be generated by the encoder 208 can be referred to as the latent space or feature space.

Conceptually, the decoder 210 is designed to map the features represented by the feature vectors 214 into meaningful output, which can depend on the task that was assigned to the transformer 212. For example, if the transformer 212 is used for a translation task, the decoder 210 can map the feature vectors 214 into text output in a target language different from the language of the original tokens 202. Generally, in a generative language model, the decoder 210 serves to decode the feature vectors 214 into a sequence of tokens. The decoder 210 can generate output tokens 216 one by one. Each output token 216 can be fed back as input to the decoder 210 in order to generate the next output token 216. By feeding back the generated output and applying self-attention, the decoder 210 is able to generate a sequence of output tokens 216 that has sequential meaning (e.g., the resulting output text sequence is understandable as a sentence and obeys grammatical rules). The decoder 210 can generate output tokens 216 until a special [EOT] token (indicating the end of the text) is generated. The resulting sequence of output tokens 216 can then be converted to a text sequence in post-processing. For example, each output token 216 can be an integer number that corresponds to a vocabulary index. By looking up the text segment using the vocabulary index, the text segment corresponding to each output token 216 can be retrieved, the text segments can be concatenated together, and the final output text sequence can be obtained.

In some examples, the input provided to the transformer 212 includes instructions to perform a function on an existing text. In some examples, the input provided to the transformer includes instructions to perform a function on an existing text. The output can include, for example, a modified version of the input text and instructions to modify the text. The modification can include summarizing, translating, correcting grammar or spelling, changing the style of the input text, lengthening or shortening the text, or changing the format of the text. For example, the input can include the question “What is the weather like in Australia?” and the output can include a description of the weather in Australia.

Although a general transformer architecture for a language model and its theory of operation have been described above, this is not intended to be limiting. Existing language models include language models that are based only on the encoder of the transformer or only on the decoder of the transformer. An encoder-only language model encodes the input text sequence into feature vectors that can then be further processed by a task-specific layer (e.g., a classification layer). BERT is an example of a language model that can be considered to be an encoder-only language model. A decoder-only language model accepts embeddings as input and can use auto-regression to generate an output text sequence. Transformer-XL and GPT-type models can be language models that are considered to be decoder-only language models.

Because GPT-type language models tend to have a large number of parameters, these language models can be considered LLMs. An example of a GPT-type LLM is GPT-3. GPT-3 is a type of GPT language model that has been trained (in an unsupervised manner) on a large corpus derived from documents available to the public online. GPT-3 has a very large number of learned parameters (on the order of hundreds of billions), is able to accept a large number of tokens as input (e.g., up to 2,048 input tokens), and is able to generate a large number of tokens as output (e.g., up to 2,048 tokens). GPT-3 has been trained as a generative model, meaning that it can process input text sequences to predictively generate a meaningful output text sequence. ChatGPT is built on top of a GPT-type LLM and has been fine-tuned with training datasets based on text-based chats (e.g., chatbot conversations). ChatGPT is designed for processing natural language, receiving chat-like inputs, and generating chat-like outputs.

A computer system can access a remote language model (e.g., a cloud-based language model), such as ChatGPT or GPT-3, via a software interface (e.g., an API). Additionally or alternatively, such a remote language model can be accessed via a network such as, for example, the Internet. In some implementations, such as, for example, potentially in the case of a cloud-based language model, a remote language model can be hosted by a computer system that can include a plurality of cooperating (e.g., cooperating via a network) computer systems that can be in, for example, a distributed arrangement. Notably, a remote language model can employ a plurality of processors (e.g., hardware processors such as, for example, processors of cooperating computer systems). Indeed, processing of inputs by an LLM can be computationally expensive/can involve a large number of operations (e.g., many instructions can be executed/large data structures can be accessed from memory), and providing output in a required timeframe (e.g., real time or near real time) can require the use of a plurality of processors/cooperating computing devices as discussed above.

Inputs to an LLM can be referred to as a prompt, which is a natural language input that includes instructions to the LLM to generate a desired output. A computer system can generate a prompt that is provided as input to the LLM via its API. As described above, the prompt can optionally be processed or pre-processed into a token sequence prior to being provided as input to the LLM via its API. A prompt can include one or more examples of the desired output, which provides the LLM with additional information to enable the LLM to generate output according to the desired output. Additionally or alternatively, the examples included in a prompt can provide inputs (e.g., example inputs) corresponding to/as can be expected to result in the desired outputs provided. A one-shot prompt refers to a prompt that includes one example, and a few-shot prompt refers to a prompt that includes multiple examples. A prompt that includes no examples can be referred to as a zero-shot prompt.

### Example Code Conversion Agentic Architecture Systems

In the realm of artificial intelligence and machine learning, agentic architecture has emerged as a powerful paradigm for designing systems that can perform complex tasks autonomously. This architecture leverages the concept of autonomous agents, which are entities capable of making decisions and taking actions independently based on their environment and objectives. The agentic architecture is particularly well-suited for applications that require distributed problem-solving and adaptive behavior, making it a valuable framework for a wide range of domains, including robotics, network management, and software development.

One of the key advancements in agentic architecture is the integration of generative models and large language models (LLMs) as agents. Generative models, such as those based on deep learning techniques, can generate new data samples that resemble a given dataset, making them useful for tasks like data augmentation, content creation, and simulation. LLMs are designed to understand and generate human-like text based on vast amounts of training data. These models, exemplified by architectures like GPT-4, can perform a variety of natural language processing tasks, including translation, summarization, and question-answering, with remarkable accuracy and fluency.

The use of generative models and LLMs as agents within an agentic architecture offers several advantages. Firstly, these models can process and generate information at a scale and speed that far surpasses human capabilities, enabling the system to handle large volumes of data efficiently. Secondly, their ability to learn from diverse datasets allows them to adapt to new tasks and environments with minimal human intervention. This adaptability can be crucial for applications where the system must respond to dynamic and unpredictable conditions, such as in autonomous vehicles or real-time decision support systems.

In the context of software development, agentic architecture can be particularly transformative. By employing LLMs as agents, the system can automate various aspects of the development process, such as code generation, debugging, and documentation. These agents can analyze existing codebases, identify potential issues, and suggest improvements, thereby enhancing the quality and maintainability of the software. Additionally, generative models can be used to create test cases and simulate different execution scenarios, helping ensure that the software is robust and reliable before deployment.

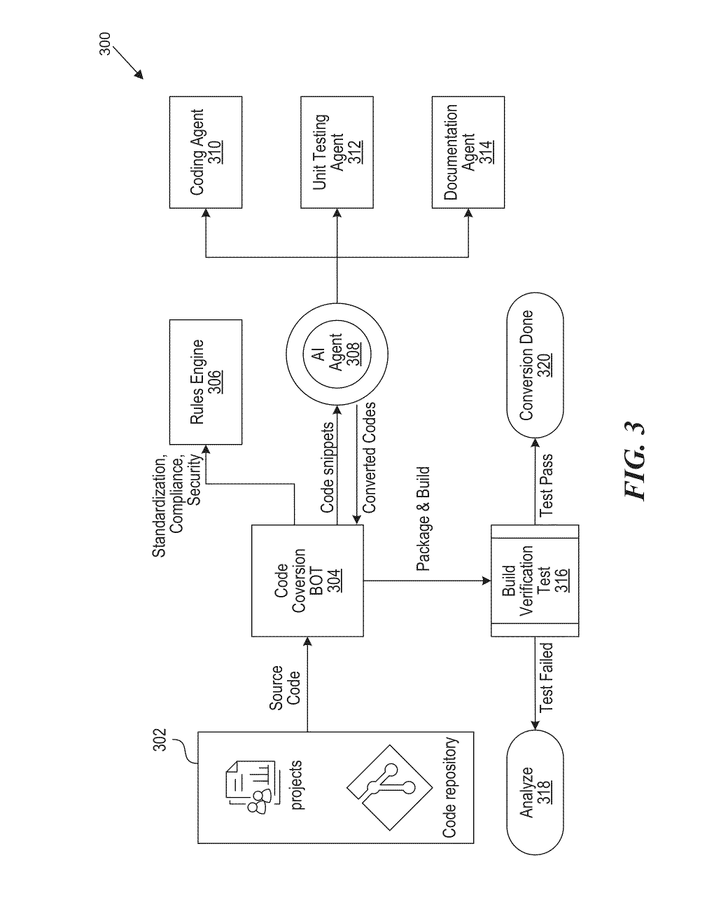

FIG. 3 is a block diagram 300 that illustrates components of a code conversion agentic architecture for converting a source code file from a first programming language to a second programming language for execution within a target programming environment, according to at least some aspects of the present technology. The programming languages can include VB, VB.NET, C#, JAVA, PYTHON, or suitable programming languages.

Repository 302 is a centralized storage system that houses various projects along with their associated source code files. These projects may include legacy systems written in outdated programming languages, which need to be converted to modern languages for better compatibility and maintainability. The code conversion bot 304 is designed to facilitate this conversion process. Upon receiving source code from repository 302, the code conversion bot 304 initiates the conversion process by transmitting the source code to the rules engine 306. The rules engine 306 can be equipped with a comprehensive set of conversion rules and heuristics tailored to handle the syntactic and semantic differences between the source and target programming languages. For example, if the source code is written in COBOL and needs to be converted to JAVA, the rules engine 306 will apply specific rules to translate COBOL constructs into their JAVA equivalents, helping ensure that the resulting code maintains its original functionality and logic.

The rules engine 306 analyzes the source code file to identify one or more conversion issues that may arise during the translation to the target programming language. These conversion issues can pertain to various aspects of the code, including coding logic, nomenclature, documentation, internal structure, or external dependencies that conflict or cause incompatibility with the target programming environment. For instance, if the source code contains encryption algorithms that are not supported or recommended in the target environment, the rules engine 306 will flag these as conversion issues.

To perform this analysis, the rules engine 306 can utilize a variety of techniques, including machine learning models, generative models, rule-based systems, or other suitable methods. For example, a machine learning model trained on a large dataset of code conversions can predict potential issues based on patterns observed in the data. Similarly, a generative model can simulate the target environment to identify conflicts and suggest appropriate modifications. A rule-based system, on the other hand, applies predefined rules to systematically check for known issues, such as naming conventions or documentation standards.

Once the rules engine 306 has processed the source code and identified the conversion issues, it transmits this information back to the code conversion bot 304. The conversion issues may include a wide range of problems, such as the use of unsuitable encryption code that does not comply with the security standards of the target programming environment, or the improper handling of user data, such as personally identifiable information (PII), which may violate data protection regulations in the target environment. Additionally, the rules engine 306 may identify coding standards issues, such as variable names or function names that do not adhere to the conventions of the target programming language.

For example, if the source code is written in PYTHON and needs to be converted to JAVA, the rules engine 306 can identify that certain PYTHON-specific libraries or functions have no direct equivalent in JAVA. It may also flag the use of dynamic typing in PYTHON, which needs to be converted to static typing in JAVA. The rules engine 306 will then provide recommendations on how to address these issues, such as suggesting alternative libraries or providing guidelines for type annotations.

The code conversion bot 304 utilizes an agentic architecture comprising a plurality of autonomous agents to process the source code file based on the identified conversion issues and generate a translated source code file. This architecture may ensure that the conversion process is efficient, accurate, and adaptable to various scenarios. The AI agent or control agent 308 plays a central role in coordinating the activities of the various autonomous agents, such that each agent performs its designated tasks effectively.

Among the autonomous agents, the coding agent 310 is responsible for the actual transformation of the source code. This agent can include specialized sub-agents such as a code transformation agent, which applies the necessary syntactic and semantic changes to convert the code from the source language to the target language. For example, if the source code is written in PYTHON and needs to be converted to JAVA, the code transformation agent will handle the conversion of PYTHON-specific constructs, such as list comprehensions, into their JAVA equivalents, such as for-loops. Additionally, the code generation agent within the coding agent 310 can generate new code segments required to replace unsupported or incompatible features in the target environment.

The unit testing agent 312 is tasked with verifying that the translated source code functions correctly and meets the desired quality standards. This agent automatically generates and executes unit tests to validate the functionality of the converted code. For instance, if the original PYTHON code includes a function for calculating the factorial of a number, the unit testing agent 312 will create corresponding test cases in JAVA to verify that the translated function produces the correct results. By automating the testing process, the unit testing agent 312 helps identify and rectify any issues early in the conversion process, thereby enhancing the reliability of the final code.

The documentation agent 314 is responsible for generating and updating the documentation for the translated source code. This agent helps ensure that the documentation is consistent with the coding standards and conventions of the target programming language. For example, if the source code includes docstrings in PYTHON, the documentation agent 314 will convert these into JAVADOC comments for JAVA, such that the documentation remains clear and informative. Proper documentation can be crucial for maintaining the readability and maintainability of the code, and the documentation agent 314 plays a role in achieving this.

The control agent 308 is responsible for determining the specific portions of the source code that need to be translated into the second programming language. This involves analyzing the source code to identify segments that are affected by the conversion issues previously identified by the rules engine 306. For example, the control agent 308 can identify a function written in PYTHON that uses dynamic typing, which needs to be converted to static typing in JAVA.

Once the relevant portions of the code are identified, the coding agent 310 takes over the processing. The coding agent 310 first generates an intermediate representation of the identified portions of the source code in the first programming language. This intermediate representation abstracts the code into a form that is easier to manipulate and transform. For instance, the coding agent 310 can convert a PYTHON function into an abstract syntax tree (AST) that represents the structure of the code without being tied to the specific syntax of PYTHON.

Based on the identified conversion issues, the coding agent 310 then processes this intermediate representation to generate a corresponding representation in the second programming language. This operation involves applying the necessary transformations to help ensure that the logic and functionality of the original code are preserved in the target language. For example, the coding agent 310 can convert a PYTHON list comprehension into a JAVA for-loop, such that the resulting code performs the same operation as the original.

After generating the corresponding representation, the coding agent 310 processes it to produce the actual translated code in the second programming language. This can involve converting the abstract representation into concrete code that adheres to the syntax and conventions of the target language. For instance, the coding agent 310 can generate a JAVA method that corresponds to the original PYTHON function, complete with appropriate type annotations and error handling. The result is one or more portions of translated code, including a first translated portion of code that can be integrated into the overall codebase.

In some implementations, the plurality of autonomous agents includes a lexical analysis agent configured to identify tokens and corresponding syntactic structures in the intermediate representation of the one or more portions of code in the first programming language. The lexical analysis agent plays a crucial role in the initial stages of the code conversion process by breaking down the source code into its fundamental components. This agent can utilize a tokenizer specific to the first programming language to accurately identify the tokens and corresponding syntactic structures. For example, if the source code is written in PYTHON, the lexical analysis agent can use a PYTHON-specific tokenizer to recognize keywords, operators, identifiers, literals, and other language constructs.

The lexical analysis agent's ability to accurately tokenize the source code can be essential for ensuring that the subsequent stages of the conversion process are based on a precise and detailed understanding of the code's structure. By identifying tokens and syntactic structures, the agent creates an intermediate representation that serves as the foundation for further analysis and transformation. This intermediate representation captures the essential elements of the source code, allowing other agents in the system to perform their tasks more effectively.

For instance, once the lexical analysis agent has tokenized the source code, a syntax analysis agent can use this intermediate representation to construct a parse tree or abstract syntax tree (AST). This tree structure represents the hierarchical organization of the code, making it easier to analyze and manipulate. The syntax analysis agent can then identify higher-level constructs such as loops, conditionals, and function definitions, which are crucial for understanding the overall logic and flow of the program.

Additionally, the lexical analysis agent can be designed to handle language-specific nuances and edge cases. For example, in a language like JAVASCRIPT, the agent must be able to recognize and correctly tokenize template literals, which allow for embedded expressions within string literals. Similarly, in a language like C++, the agent must handle preprocessor directives and macros, which can significantly alter the structure of the code. By incorporating these language-specific considerations, the lexical analysis agent can help ensure that the intermediate representation is both accurate and comprehensive.

In some implementations, the plurality of autonomous agents includes a semantic analysis agent configured to determine the meaning and corresponding context of the identified tokens and syntactic structures. The semantic analysis agent plays a pivotal role in the code conversion process by interpreting the intermediate representation generated by the lexical analysis agent. This agent employs context-aware analysis techniques to accurately determine the meaning and context of the identified tokens and structures. For example, if the source code is written in JAVA, the semantic analysis agent can analyze the intermediate representation to understand the relationships between variables, functions, classes, and other constructs, such that the translated code maintains the original program's logic and behavior.

The semantic analysis agent's ability to understand the context and meaning of code elements can be crucial for ensuring that the conversion process preserves the intended functionality of the source code. By leveraging advanced techniques such as abstract interpretation, data flow analysis, and type inference, the agent can accurately determine how different parts of the code interact with each other. For instance, in a PYTHON codebase, the semantic analysis agent can use type inference to deduce the types of dynamically-typed variables, which can be essential for translating the code into a statically-typed language like JAVA.

To illustrate, consider a scenario where the source code includes a function that manipulates a complex data structure, such as a nested dictionary in PYTHON. The semantic analysis agent can analyze the function to understand how it accesses and modifies the dictionary's elements. This analysis involves tracking variable scopes, resolving references, and understanding the effects of different operations on the data structure. By accurately capturing this information, the agent can help ensure that the translated code in the target language, such as C#, correctly replicates the original function's behavior.

Furthermore, the semantic analysis agent can handle language-specific features and idioms that require a deep understanding of the source language's semantics. For example, in JAVASCRIPT, the agent must correctly interpret closures and asynchronous functions, which have unique execution contexts and behaviors. Similarly, in C++, the agent must handle template metaprogramming and operator overloading, which introduce additional layers of complexity. By incorporating these language-specific considerations, the semantic analysis agent can help ensure that the translated code is both accurate and idiomatic in the target language.

Unit testing agent 312 processes the first translated portion of code to generate one or more unit tests for validating the first translated portion of code. These unit tests can cover various scenarios, such as testing login and password input and output, applying password rules, or other relevant functionalities. For example, if the translated code includes a function for user authentication, the unit testing agent 312 can generate tests to verify that the function correctly handles valid and invalid login attempts, enforces password complexity rules, and manages session tokens appropriately.

The unit testing agent 312 employs advanced techniques to conduct comprehensive test coverage of the translated code. This includes analyzing the code to identify critical paths, edge cases, and potential failure points. By doing so, the agent can generate unit tests that thoroughly exercise the code, such that all relevant scenarios are tested. For instance, in a JAVA codebase, the unit testing agent 312 can use a combination of static analysis and dynamic analysis to identify all possible execution paths within a method, generating tests that cover each path to help ensure complete validation.

To ensure the effectiveness of the generated unit tests, the unit testing agent 312 verifies that the code coverage meets or exceeds a predefined threshold. Code coverage is a measure of how much of the code is exercised by the tests, typically expressed as a percentage. For example, if the translated code consists of 100 lines, the unit testing agent 312 can aim for at least 80% code coverage, meaning that at least 80 lines of code are executed by the tests. If the coverage falls below this threshold, the agent can identify the uncovered portions of the code and generate additional tests to improve coverage.

In some cases, if the unit testing agent 312 determines that the code coverage is insufficient, it can trigger a retraining process for the coding agent responsible for the translation. This retraining process involves refining the coding agent's algorithms and heuristics to produce more testable and reliable code. For example, if the initial translation of a PYTHON function to C# results in low test coverage, the coding agent can be retrained to better handle the specific constructs and idioms of C#, leading to improved code quality and higher test coverage in subsequent translations.

The documentation agent 314 processes the first translated portion of code based on a predefined documentation template to determine the corresponding documentation. This agent can play a crucial role in ensuring that the translated code is well-documented, which can be essential for maintainability and future development. For example, if the source code is written in PYTHON and translated to JAVA, the documentation agent 314 can generate JAVADOC comments that accurately describe the functionality, parameters, and return values of the translated methods.

The documentation agent 314 employs advanced techniques to extract relevant information from the source code and incorporate it into the documentation for the translated code. This includes extracting comments and annotations from the source code file and mapping them to the corresponding elements in the translated code. For instance, if the source code includes a PYTHON function with a docstring describing its purpose and parameters, the documentation agent 314 can extract this information and generate a corresponding JAVADOC comment for the translated JAVA method. This can help ensure that the original documentation is preserved and adapted to the target language's conventions.

To illustrate, consider a scenario where the source code includes a class with multiple methods, each accompanied by detailed comments explaining their functionality. The documentation agent 314 can analyze the class and its methods, extracting the comments and incorporating them into the translated code's documentation. This process can involve identifying the corresponding elements in the translated code and ensuring that the comments are accurately mapped. For example, a PYTHON method with a comment describing its parameters and return value can be translated into a JAVA method with a JAVADOC comment that includes the same information, formatted according to JAVADOC conventions.

Additionally, the documentation agent 314 can enhance the generated documentation by incorporating additional context and details. This includes generating summaries for classes and methods, describing their roles within the overall codebase, and providing examples of usage. For example, if the translated code includes a complex algorithm, the documentation agent 314 can generate a detailed explanation of the algorithm's logic, along with code snippets demonstrating its usage. This can help ensure that the documentation is not only accurate but also informative and helpful for developers.

In some implementations, the code conversion bot 304 is responsible for transmitting the translated source code to the rules engine 306 for final validation. The rules engine 306 processes the translated source code file to determine whether any conversion issues remain that conflict or cause incompatibility with the target programming environment. This validation step can be crucial for ensuring that the translated code is fully compatible and ready for deployment. For example, if the source code was translated from PYTHON to JAVA, the rules engine 306 can verify that the translated JAVA code adheres to JAVA's syntax, semantics, and platform-specific requirements.

The rules engine 306 employs a comprehensive set of validation rules to analyze the translated code. These rules cover various aspects of code quality, including syntax correctness, adherence to coding standards, and compatibility with the target environment. For instance, the rules engine 306 can check for common issues such as missing imports, incorrect type conversions, and platform-specific dependencies. By systematically applying these rules, the engine can help ensure that the translated code is free from errors and ready for execution.

Once the rules engine 306 determines that no conversion issues remain, the code conversion bot 304 proceeds to output the translated source code file along with the corresponding unit tests and documentation. This output process involves packaging the translated code and its associated artifacts in a format suitable for deployment. For example, the code conversion bot 304 can generate a JAVA archive (JAR) file containing the translated JAVA code, unit tests, and JAVADOC documentation, making it easy to integrate into the target environment.

In some implementations, outputting the translated source code file includes checking the translated code into a version control repository, such as repository 302. This operation can help ensure that the translated code is properly versioned and accessible to the development team. For instance, the code conversion bot 304 can use GIT commands to commit the translated code, unit tests, and documentation to a GIT repository, providing a clear history of changes and facilitating collaboration among developers.

In some implementations, if the rules engine 306 determines that at least some conversion issues remain, the code conversion bot 304 initiates a reprocessing cycle using the agentic architecture. This reprocessing involves addressing the identified conversion issues to generate an improved translated source code file. For example, if the initial translation from PYTHON to JAVA results in type mismatch errors or unresolved dependencies, the code conversion bot 304 will reprocess the code to correct these issues.

The reprocessing cycle leverages the capabilities of the various autonomous agents within the system to address the specific conversion issues. For instance, the lexical analysis agent may re-tokenize the problematic portions of the code, while the semantic analysis agent re-evaluates the context and meaning of the affected code segments. This collaborative approach can help ensure that the reprocessing is thorough and targeted, addressing the root causes of the conversion issues.

To illustrate, consider a scenario where the translated JAVA code contains a method that fails to compile due to a type mismatch. The semantic analysis agent can re-analyze the method to determine the correct types for the variables and parameters involved. The coding agent can then regenerate the method with the corrected types, such that the code compiles successfully. This iterative process continues until all identified conversion issues are resolved.

Additionally, the unit testing agent 312 plays a crucial role in the reprocessing cycle by generating new unit tests to validate the reprocessed code. These tests can help ensure that the corrections made during reprocessing do not introduce new issues and that the translated code maintains its intended functionality. For example, if the reprocessed code includes a corrected method, the unit testing agent 312 can generate tests to verify that the method behaves as expected under various scenarios.

Once the reprocessing cycle is complete and the rules engine 306 verifies that no conversion issues remain, the code conversion bot 304 outputs the improved translated source code file along with the corresponding unit tests and documentation. This can help ensure that the final output is of high quality and ready for deployment. For instance, the reprocessed JAVA code, now free of type mismatches and other issues, can be packaged with its unit tests and JAVADOC comments, providing a comprehensive and reliable codebase for the development team.

In some implementations, the code conversion bot 304 transmits the translated source code to the build, verification, and test (BVT) module 316. The BVT module 316 is responsible for packaging and building the translated source code file into executable built code. This process involves compiling the code, resolving dependencies, and generating the necessary binaries for execution. For example, if the translated code is in JAVA, the BVT module 316 can use a build tool like Maven or Gradle to compile the JAVA source files, package them into a JAR file, and manage any external dependencies.

Once the code is built, the analyze module 318 executes verification testing on the built code using the corresponding unit tests generated by the unit testing agent 312. This verification testing can help ensure that the built code behaves as expected and meets the required quality standards. For instance, the analyze module 318 can run the unit tests to verify that all methods and functions in the translated JAVA code produce the correct outputs, handle edge cases, and maintain the intended functionality.

In some implementations, if the analyze module 318 determines that the built code has failed verification testing, the code conversion bot 304 or another suitable entity analyzes the translated source code file to identify any requirements for the target programming environment that were missed by the rules engine 306. This analysis involves examining the failed tests and identifying the specific issues that caused the failures. For example, if the translated JAVA code fails a unit test due to an unhandled exception, the analysis can determine that the rules engine 306 missed a requirement related to exception handling in JAVA.

To address these issues, the machine learning model, generative model, rule-based system, or other means included in the rules engine 306 is updated to include the identified requirements in future analyses for conversion issues. This update process involves refining the rules engine's algorithms and heuristics to better handle the specific requirements of the target programming environment. For instance, if the rules engine 306 missed a requirement related to JAVA's exception handling, the update can help ensure that future translations include the necessary try-catch blocks to handle exceptions appropriately.

### Methods of Operation of the Example Systems

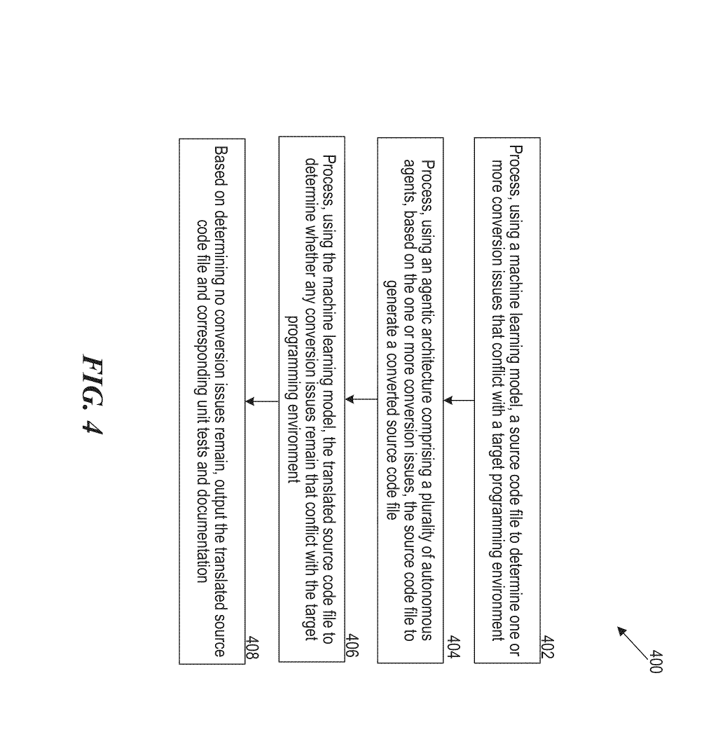

FIG. 4 is a flow diagram that illustrates process 400 for executing a code conversion agentic architecture, according to at least some aspects of the present technology. For example, process 400 may represent the operations taken by one or more devices discussed in relation to FIGS. 1-3 and 6.

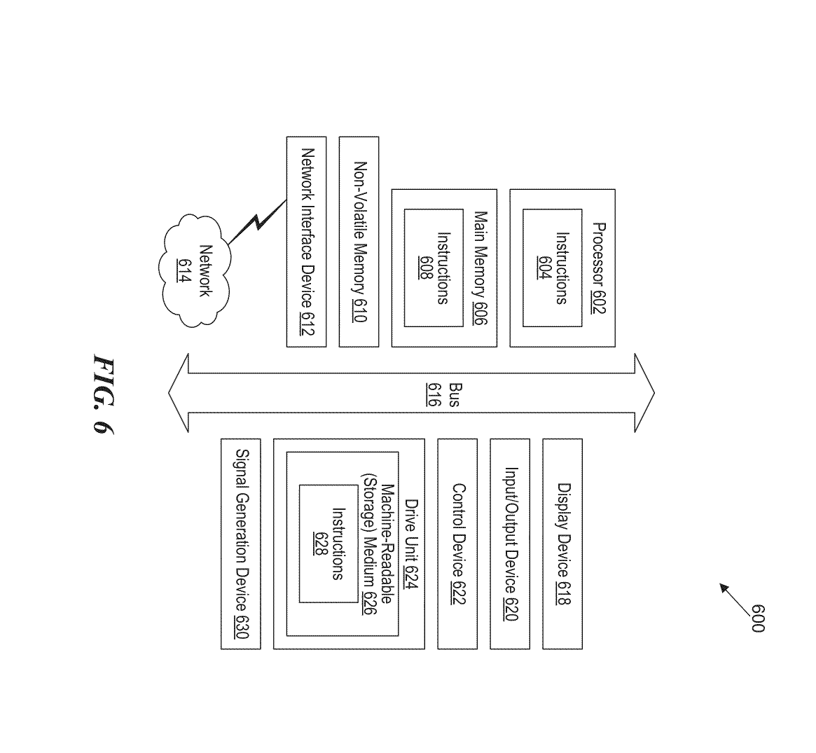

In operation, at 402, the system (e.g., system 600 (FIG. 6)) processes, using a machine learning model, a source code file to determine one or more conversion issues related to coding logic, nomenclature, documentation, internal structure, or external dependencies that conflict or cause incompatibility with the target programming environment. For example, the machine learning model, as depicted in FIG. 2, is trained to identify discrepancies in coding logic between the source and target languages. If the source code is written in PYTHON and the target language is JAVA, the model can detect that PYTHON's dynamic typing needs to be converted to JAVA's static typing, which requires explicit type declarations. Additionally, the model can identify nomenclature issues, such as converting PYTHON's variable names to JAVA’s naming convention, such that the translated code adheres to the target language's standards.

At 404, the system processes, using an agentic architecture comprising a plurality of autonomous agents, based on the one or more conversion issues, the source code file to generate a translated source code file. As illustrated in FIG. 3, the agentic architecture can include various specialized agents such as the coding agent, the unit testing agent, and the documentation agent. For instance, the coding agent generates the translated source code file by applying necessary transformations. For example, if the source code includes a PYTHON function with dynamic typing, the coding agent can convert it to a JAVA method with explicit type declarations, helping ensure compatibility with the target environment. In some implementations, the control agent and/or some or all of the autonomous agents are included or combined into a single agent and/or a combination of agents. This single agent can be configured to perform the same functionality that would be otherwise performed by the agents that have been included or combined into the single agent. For example, consider a scenario where the coding agent, unit testing agent, and documentation agent are combined into a single multi-functional agent. This single agent can handle the entire process of code translation, testing, and documentation generation. In the context of code translation, the single agent can transform a PYTHON function with dynamic typing into a JAVA method with explicit type declarations. Similarly, for unit testing, the single agent can convert a PYTHON unit test using the unit test framework into a JAVA unit test using the JUnit framework. Furthermore, the single agent can also handle documentation generation by converting documentation formats to match the conventions of the target language.

At 406, the system processes the translated source code file to determine whether any conversion issues remain that conflict or cause incompatibility with the target programming environment. This operation can involve using the rules engine 306, as depicted in FIG. 3, to validate the translated code against a comprehensive set of rules. For example, the rules engine can check for syntax correctness, adherence to coding standards, and compatibility with platform-specific requirements. If the translated JAVA code contains any unresolved dependencies or type mismatches, the rules engine can identify these issues and flag them for further processing.

At 408, based on determining no conversion issues remain, the system outputs the translated source code file and corresponding unit tests and documentation. In some implementations, outputting the translated source code file includes checking the translated source code file into a code repository, such as repository 302. For instance, the code conversion bot 304 can use GIT commands to commit the translated code, unit tests, and documentation to a GIT repository, providing a clear history of changes and facilitating collaboration among developers. This can help ensure that the translated code is properly versioned and accessible to the development team.

In some implementations, in response to determining that at least some conversion issues remain, the system reprocesses, using the agentic architecture, based on the at least some conversion issues, the translated source code file to generate another translated source code file. This reprocessing can involve addressing the identified conversion issues by leveraging the capabilities of the various autonomous agents. For example, if the initial translation results in type mismatch errors, the semantic analysis agent can re-evaluate the affected code segments, and the coding agent can regenerate the code with the corrected types. This iterative process continues until all identified conversion issues are resolved.

In some implementations, the system packs and builds the translated source code file into built code. The system executes verification testing of the built code using the corresponding unit tests. As illustrated in FIG. 3, the build, verification, and test (BVT) module 316 packages and builds the translated code, while the analyze module 318 executes the verification tests. For example, the BVT module can use a build tool like Maven to compile the JAVA code and generate a JAR file, and the analyze module can run the unit tests to help ensure that the code behaves as expected and meets the required quality standards.

In some implementations, in response to determining the built code has failed verification testing, the system analyzes the translated source code file to determine at least one requirement for the target programming environment that was missed by the machine learning model. The system retrains the machine learning model to include the at least one requirement in future analysis for conversion issues. For instance, if the verification tests reveal that the translated JAVA code fails due to an unhandled exception, the system can update the machine learning model to better handle exception handling in future translations. This continuous improvement process can help ensure that the system becomes more accurate and effective over time, as it learns from past conversion issues and adapts to the specific requirements of the target environment.

It is contemplated that the operations or descriptions of FIG. 4 may be used with any other implementation of this disclosure. In addition, the operations and descriptions described in relation to FIG. 4 may be done in alternative orders or in parallel to further the purposes of this disclosure. For example, each of these operations may be performed in any order, in parallel, or simultaneously to reduce lag or increase the speed of the system or method. Furthermore, it should be noted that any of the devices or equipment discussed in relation to FIGS. 1-3 and 6 could be used to perform one or more of the operations in FIG. 4.

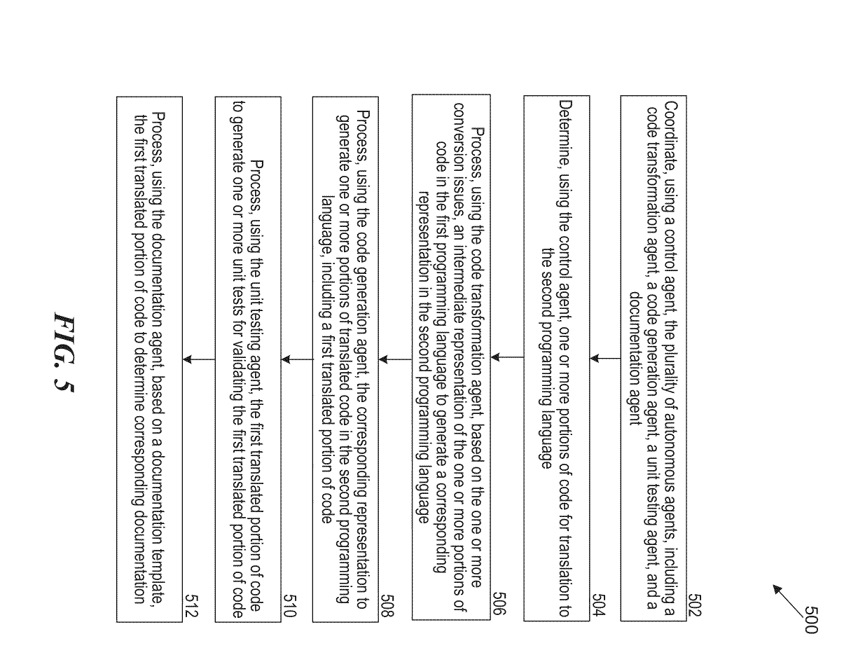

FIG. 5 is a flow diagram that illustrates process 500 for executing a code conversion agentic architecture, according to at least some aspects of the present technology. Process 500 is an illustrative example of operations executed by the system for processing, using an agentic architecture comprising a plurality of autonomous agents, based on the one or more conversion issues, the source code file to generate a translated source code file (e.g., operation 402 (FIG. 4)). For example, process 500 may represent the operations taken by one or more devices discussed in relation to FIGS. 1-3 and 6.

In operation, at 502, the system (e.g., system 600 (FIG. 6)) coordinates the plurality of autonomous agents, including a code transformation agent, a code generation agent, a unit testing agent, and a documentation agent. For example, the code transformation agent is responsible for converting the structure and syntax of the source code, while the code generation agent creates new code segments in the target language. The unit testing agent generates and executes tests to validate the translated code, and the documentation agent ensures that comments and annotations are accurately transferred and formatted. This coordination allows for each aspect of the code conversion process to be handled by specialized agents, improving the overall efficiency and accuracy of the system.

At 504, the system determines one or more portions of code for translation to the second programming language. This involves analyzing the source code to identify segments that require conversion. For instance, if the source code is written in PYTHON and the target language is JAVA, the system can identify functions, classes, and modules that need to be translated. The system can use the machine learning model, as depicted in FIG. 2, to prioritize these portions based on their complexity and interdependencies, ensuring that the most critical sections are addressed first.

At 506, the system processes, based on the one or more conversion issues, an intermediate representation of the one or more portions of code in the first programming language to generate a corresponding representation in the second programming language. This intermediate representation serves as a bridge between the source and target languages, capturing the essential logic and structure of the code. For example, the system can convert a PYTHON function into an abstract syntax tree (AST) that represents its logic, which can then be transformed into a corresponding JAVA method. This can help ensure that the core functionality of the code is preserved during the translation process.

At 508, the system processes the corresponding representation to generate one or more portions of translated code in the second programming language, including a first translated portion of code. For instance, the system can take the intermediate representation of a PYTHON function and generate the equivalent JAVA method, such that all necessary type declarations and syntax adjustments are made. This operation can involve the code generation agent, which uses predefined templates and rules to produce syntactically correct and semantically equivalent code in the target language.

In some implementations, the plurality of autonomous agents includes a lexical analysis agent configured to identify tokens and corresponding syntactic structures in the intermediate representation of the one or more portions of code in the first programming language. The lexical analysis agent can utilize a tokenizer specific to the first programming language to identify the tokens and corresponding syntactic structures. For example, if the source code is in PYTHON, the lexical analysis agent can use a PYTHON-specific tokenizer to break down the code into tokens such as keywords, operators, and identifiers, which are then used to construct the intermediate representation.

In some implementations, the plurality of autonomous agents includes a semantic analysis agent configured to determine meaning and corresponding context of the identified tokens and corresponding syntactic structures. The semantic analysis agent can employ a context-aware analysis technique to determine the meaning and corresponding context of the identified tokens and structures. For instance, the semantic analysis agent can analyze a PYTHON function to understand its purpose, input parameters, and return values, such that this information is accurately reflected in the translated JAVA method. This context-aware analysis helps maintain the functionality and intent of the original code.

At 510, the system processes the first translated portion of code to generate one or more unit tests for validating the first translated portion of code. The unit testing agent, as illustrated in FIG. 3, can create tests that cover various scenarios and edge cases to help ensure that the translated code behaves as expected. For example, if the translated code includes a JAVA method, the unit testing agent can generate unit tests to validate its functionality, checking for correct outputs, exception handling, and performance under different conditions.

In some implementations, generating the one or more unit tests for validating the first translated portion of code includes verifying code coverage of the one or more unit tests with respect to the first translated portion of code meets or exceeds a threshold. For instance, the system can use a code coverage tool to measure the percentage of code executed by the unit tests, ensuring that it meets a predefined threshold, such as 80% coverage. This operation may help ensure that the translated code is thoroughly tested and reliable.

At 512, the system processes, based on a documentation template, the first translated portion of code to determine corresponding documentation. The documentation agent, as depicted in FIG. 3, can use predefined templates to generate documentation that is consistent with the standards of the target programming language. For example, if the translated code is in JAVA, the documentation agent can generate JAVADOC comments that describe the purpose, parameters, and return values of each method, such that the documentation is clear and informative.

In some implementations, the system extracts comments and annotations from the source code file and incorporates them into the corresponding documentation for the translated source code file. For instance, if the source code includes detailed docstrings in PYTHON, the system can convert these to JAVADOC comments in the translated JAVA code, maintaining the original documentation's clarity and detail. This operation may help ensure that the translated code is well-documented and easy to understand for future developers.

It is contemplated that the operations or descriptions of FIG. 5 may be used with any other implementation of this disclosure. In addition, the operations and descriptions described in relation to FIG. 5 may be done in alternative orders or in parallel to further the purposes of this disclosure. For example, each of these operations may be performed in any order, in parallel, or simultaneously to reduce lag or increase the speed of the system or method. Furthermore, it should be noted that any of the devices or equipment discussed in relation to FIGS. 1-3 and 6 could be used to perform one or more of the operations in FIG. 5.

### Computer System

FIG. 6 is a block diagram that illustrates an example of a computer system 600 in which at least some operations described herein can be implemented. As shown, the computer system 600 can include: one or more processors 602, main memory 606, non-volatile memory 610, a network interface device 612, a video display device 618, an input/output device 620, a control device 622 (e.g., keyboard and pointing device), a drive unit 624 that includes a machine-readable (storage) medium 626, and a signal generation device 630 that are communicatively connected to a bus 616. The bus 616 represents one or more physical buses and/or point-to-point connections that are connected by appropriate bridges, adapters, or controllers. Various common components (e.g., cache memory) are omitted from FIG. 6 for brevity. Instead, the computer system 600 is intended to illustrate a hardware device on which components illustrated or described relative to the examples of the figures and any other components described in this specification can be implemented.

The computer system 600 can take any suitable physical form. For example, the computing system 600 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 600. In some implementations, the computer system 600 can be an embedded computer system, a system-on-chip (SOC), a single-board computer system (SBC), or a distributed system such as a mesh of computer systems, or it can include one or more cloud components in one or more networks. Where appropriate, one or more computer systems 600 can perform operations in real time, in near real time, or in batch mode.

The network interface device 612 enables the computing system 600 to mediate data in a network 614 with an entity that is external to the computing system 600 through any communication protocol supported by the computing system 600 and the external entity. Examples of the network interface device 612 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 606, non-volatile memory 610, machine-readable medium 626) can be local, remote, or distributed. Although shown as a single medium, the machine-readable medium 626 can include multiple media (e.g., a centralized/distributed database and/or associated caches and servers) that store one or more sets of instructions 628. The machine-readable medium 626 can include any medium that is capable of storing, encoding, or carrying a set of instructions for execution by the computing system 600. The machine-readable medium 626 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory 610, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 604, 608, 628) set at various times in various memory and storage devices in computing device(s). When read and executed by the processor 602, the instruction(s) cause the computing system 600 to perform operations to execute elements involving the various aspects of the disclosure.

### Remarks

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not for other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

We claim:

1. A system for converting a source code file from a first programming language to a second programming language for execution within a target programming environment, the system comprising:
one or more processors; and
one or more non-transitory, computer-readable media comprising instructions that, when executed by the one or more processors, cause operations comprising:
processing, using a machine learning model, a source code file to determine one or more conversion issues related to coding logic, nomenclature, documentation, internal structure, or external dependencies that conflict with the target programming environment;
using the one or more conversion issues, processing the source code file, via an agentic architecture comprising a plurality of autonomous agents, to generate a translated source code file, the processing comprising:
coordinating, using a control agent, the plurality of autonomous agents, including a code transformation agent, a code generation agent, a unit testing agent, and a documentation agent;
determining, using the control agent, one or more portions of code for translation to the second programming language;
processing, using the code transformation agent, based on the one or more conversion issues, an intermediate representation of the one or more portions of code in the first programming language to generate a corresponding representation in the second programming language;
processing, using the code generation agent, the corresponding representation to generate one or more portions of translated code in the second programming language, including a first translated portion of code;
processing, using the unit testing agent, the first translated portion of code to generate one or more unit tests for validating the first translated portion of code; and
processing, using the documentation agent, based on a documentation template, the first translated portion of code to determine corresponding documentation;
inputting the translated source code file into the machine learning model to determine whether any conversion issues remain that conflict with the target programming environment; and
based on determining no conversion issues remain, outputting the translated source code file and corresponding unit tests and documentation.

2. The system of claim 1, wherein the operations further comprise:
in response to determining that at least some conversion issues remain, reprocessing, using the agentic architecture, based on the at least some conversion issues, the translated source code file to generate another translated source code file.

3. The system of claim 1, wherein the operations further comprise:
retrieving the source code file from a code repository,
wherein outputting the translated source code file includes checking the translated source code file into the code repository.

4. The system of claim 1, wherein generating the one or more unit tests for validating the first translated portion of code includes verifying code coverage of the one or more unit tests with respect to the first translated portion of code meets or exceeds a threshold.

5. The system of claim 1, wherein the control agent and/or at least one of the plurality of autonomous agents are included in a single agent configured to perform functionality related to the control agent and/or at least one of the plurality of autonomous agents.

6. The system of claim 1, wherein the operations further comprise:
packing and building the translated source code file into built code;
executing verification testing of the built code using the corresponding unit tests;
in response to determining the built code has failed verification testing, analyzing the translated source code file to determine at least one requirement for the target programming environment that was missed by the machine learning model; and
retraining the machine learning model to include the at least one requirement in future analysis for conversion issues.

7. The system of claim 1, wherein the plurality of autonomous agents includes a lexical analysis agent configured to identify tokens and corresponding syntactic structures in the intermediate representation of the one or more portions of code in the first programming language, wherein the lexical analysis agent utilizes a tokenizer specific to the first programming language to identify the tokens and corresponding syntactic structures.

8. The system of claim 7, wherein the plurality of autonomous agents includes a semantic analysis agent configured to determine meaning and corresponding context of the identified tokens and corresponding syntactic structures, wherein the semantic analysis agent employs a context-aware analysis technique to determine the meaning and corresponding context of the identified tokens and structures.

9. The system of claim 1, wherein the documentation agent extracts comments and annotations from the source code file and incorporates them into the corresponding documentation for the translated source code file.

10. A method for converting a source code file from a first programming language to a second programming language for execution within a target programming environment, the method comprising:
processing, using a machine learning model, a source code file to determine one or more conversion issues that cause incompatibility with the target programming environment;
using the one or more conversion issues, processing, the source code file, via an agentic architecture comprising a plurality of autonomous agents, to generate a translated source code file, the processing comprising:
coordinating, using a control agent, the plurality of autonomous agents, including a code transformation agent and a code generation agent;
determining, using the control agent, one or more portions of code for translation to the second programming language;
processing, using the code transformation agent, based on the one or more conversion issues, an intermediate representation of the one or more portions of code in the first programming language to generate a corresponding representation in the second programming language; and
processing, using the code generation agent, the corresponding representation to generate one or more portions of translated code in the second programming language, including a first translated portion of code;
inputting the translated source code file into a machine learning model to determine whether any conversion issues remain that cause incompatibility with the target programming environment; and
based on determining no conversion issues remain, outputting the translated source code file.

11. The method of claim 10, further comprising:
processing, using a unit testing agent included in the plurality of autonomous agents, the first translated portion of code to generate one or more unit tests for validating the first translated portion of code, wherein generating the one or more unit tests for validating the first translated portion of code includes verifying code coverage of the one or more unit tests with respect to the first translated portion of code meets or exceeds a threshold; and
processing, using a documentation agent included in the plurality of autonomous agents, based on a documentation template, the first translated portion of code to determine corresponding documentation, wherein the documentation agent extracts comments and annotations from the source code file and incorporates them into the corresponding documentation for the translated source code file.

12. The method of claim 10, further comprising:
in response to determining that at least some conversion issues remain, reprocessing, using the agentic architecture, based on the at least some conversion issues, the translated source code file to generate another translated source code file.

13. The method of claim 10, further comprising:
retrieving the source code file from a code repository,
wherein outputting the translated source code file includes checking the translated source code file into the code repository.

14. The method of claim 11, further comprising:
packing and building the translated source code file into built code;
executing verification testing of the built code using corresponding unit tests;
in response to determining the built code has failed verification testing, analyzing the translated source code file to determine at least one requirement for the target programming environment that was missed by the machine learning model; and
retraining the machine learning model to include the at least one requirement in future analysis for conversion issues.

15. The method of claim 10, wherein the plurality of autonomous agents includes a lexical analysis agent configured to identify tokens and corresponding syntactic structures in the intermediate representation of the one or more portions of code in the first programming language, wherein the lexical analysis agent utilizes a tokenizer specific to the first programming language to identify the tokens and corresponding syntactic structures.

16. The method of claim 15, wherein the plurality of autonomous agents includes a semantic analysis agent configured to determine meaning and corresponding context of the identified tokens and corresponding syntactic structures, wherein the semantic analysis agent employs a context-aware analysis technique to determine the meaning and corresponding context of the identified tokens and structures.

17. One or more non-transitory, computer-readable media comprising instructions for converting a source code file from a first programming language to a second programming language for execution within a target programming environment that, when executed by one or more processors, cause operations comprising:
processing a source code file to determine one or more conversion issues that cause incompatibility with a target programming environment;
using the one or more conversion issues, processing the source code file, via an agentic architecture comprising a plurality of autonomous agents, to generate a translated source code file;
processing the translated source code file to determine whether any conversion issues remain that cause incompatibility with the target programming environment; and
based on determining no conversion issues remain, outputting the translated source code file.

18. The one or more non-transitory, computer-readable media of claim 17, wherein, using the one or more conversion issues, processing, the source code file, via an agentic architecture comprising a plurality of autonomous agents, to generate a translated source code file comprises:
coordinating, using a control agent, the plurality of autonomous agents, including a code transformation agent and a code generation agent;
determining, using the control agent, one or more portions of code for translation to the second programming language;
processing, using the code transformation agent, based on the one or more conversion issues, an intermediate representation of the one or more portions of code in the first programming language to generate a corresponding representation in the second programming language; and
processing, using the code generation agent, the corresponding representation to generate one or more portions of translated code in the second programming language, including a first translated portion of code.

19. The one or more non-transitory, computer-readable media of claim 18, wherein, the operations further comprise:
processing, using a unit testing agent included in the plurality of autonomous agents, the first translated portion of code to generate one or more unit tests for validating the first translated portion of code, wherein generating the one or more unit tests for validating the first translated portion of code includes verifying code coverage of the one or more unit tests with respect to the first translated portion of code meets or exceeds a threshold; and
processing, using a documentation agent included in the plurality of autonomous agents, based on a documentation template, the first translated portion of code to determine corresponding documentation, wherein the documentation agent extracts comments and annotations from the source code file and incorporates them into the corresponding documentation for the translated source code file.

20. The one or more non-transitory, computer-readable media of claim 17, wherein the operations further comprise:
packing and building the translated source code file into built code;
executing verification testing of the built code using corresponding unit tests;
in response to determining the built code has failed verification testing, analyzing the translated source code file to determine at least one requirement for the target programming environment that was missed by a machine learning model used to process the translated source code file; and
retraining the machine learning model to include the at least one requirement in future analysis for conversion issues.
